(19) United States
(12) Patent Application Publication
(10) Pub. No.: US 2025/0193615 A1
(43) Pub. Date: Jun. 12, 2025

(54) ACTIVE DEBRIS REMOVAL FOR EAR-WORN DEVICE

(71) Applicant: Starkey Laboratories, Inc., Eden Prairie, MN (US)

(72) Inventor: Viktor Klymko, Minneapolis, MN (US)

(21) Appl. No.: 18/960,404

(22) Filed: Nov. 26, 2024

Related U.S. Application Data
(60) Provisional application No. 63/603,920, filed on Nov. 29, 2023.

(51) Int. Cl. H04R 25/00

(52) U.S. Cl. CPC H04R 25/65

(57) ABSTRACT

Embodiments herein relate to ear-worn devices having active debris removal. In an embodiment, an ear-worn device is included having a housing defining an acoustic outlet, a receiver disposed within the housing, an acoustic channel having an acoustic channel wall formed by the housing, wherein the acoustic is channel defined between the receiver and the acoustic outlet. The ear-worn device can include a first actuator disposed within the acoustic channel and extending from the acoustic channel wall toward the center of the acoustic channel. The first actuator can include a piezoelectric layer, a power source electrically connected to the first actuator, and an actuator control device configured to apply a control voltage from the power source to the actuator. The first actuator moves in response to the application of the control voltage. Other embodiments are also included herein.

### RELATED APPLICATIONS

This application claims the benefit of U.S. Provisional Application No. 63/603,920, filed Oct. 29, 2023, the content of which is incorporated herein by reference in its entirety.

### TECHNICAL FIELD

Embodiments herein relate to ear-worn devices and more particularly to ear-worn devices having active debris removal.

### BACKGROUND OF THE INVENTION

Modern hearing assistance devices, such as hearing aids, are electronic instruments worn in or around the ear that compensate for hearing losses by amplifying sound. Hearing aids typically include an enclosure or housing with one or more openings for a microphone that senses sound, hearing assistance device electronics including processing electronics, and a speaker or receiver to play processed sound for the wearer. One of the recurring problems with such devices is the accumulation of foreign matter interfering with the performance of the internal components. The accumulation of foreign material in hearing assistances devices reduces both the overall lifetime of the device and the maximum time the device can perform adequately between cleanings.

### SUMMARY OF THE INVENTION

In a first aspect, an ear-worn device can be included having a housing defining an acoustic outlet, a receiver disposed within the housing, an acoustic channel having an acoustic channel wall formed by the housing, wherein the acoustic can be channel defined between the receiver and the acoustic outlet. The ear-worn device can include a first actuator disposed within the acoustic channel and extending from the acoustic channel wall toward a center of the acoustic channel. The first actuator can include a piezoelectric layer, a power source electrically connected to the first actuator, and an actuator control device configured to apply a control voltage from the power source to the actuator. The first actuator is configured to move in response to the application of the control voltage.

In a second aspect, in addition to one or more of the preceding or following aspects, or in the alternative to some aspects, the first actuator can be configured to remove debris from the acoustic channel.

In a third aspect, in addition to one or more of the preceding or following aspects, or in the alternative to some aspects, the first actuator can be a part of a first actuator array disposed within the acoustic channel. The first actuator array further can include a second actuator disposed within the acoustic channel and extending from the acoustic channel wall toward the center of the acoustic channel. The second actuator can include a piezoelectric layer, wherein the power source can be electrically connected to the first actuator array. The actuator control device can be configured to apply a control voltage from the power source to the first actuator array, and wherein each of the first plurality of actuators moves in response to the application of the control voltage.

In a fourth aspect, in addition to one or more of the preceding or following aspects, or in the alternative to some aspects, the first actuator array includes at least ten actuators.

In a fifth aspect, in addition to one or more of the preceding or following aspects, or in the alternative to some aspects, further can include a second actuator array disposed between the first actuator array and the acoustic outlet, the second actuator array can include a second plurality of actuators surrounding a second perimeter of the acoustic channel wall. Each of the second plurality of actuators extends from the acoustic channel wall toward the center of the acoustic channel.

In a sixth aspect, in addition to one or more of the preceding or following aspects, or in the alternative to some aspects, the actuator control device can be configured to apply the control voltage from the power source to the second actuator array after applying the control voltage from the power source to the first actuator array.

In a seventh aspect, in addition to one or more of the preceding or following aspects, or in the alternative to some aspects, the actuator control device can be configured to apply the control voltage from the power source to the second actuator array between about 100 milliseconds and one second after applying the control voltage from the power source to the first actuator array.

In an eighth aspect, in addition to one or more of the preceding or following aspects, or in the alternative to some aspects, wherein each of the second plurality of actuators have an angular offset with respect to each of the first actuator and the second actuator.

In a ninth aspect, in addition to one or more of the preceding or following aspects, or in the alternative to some aspects, further can include a third actuator array disposed between the second actuator array and the acoustic outlet, the second actuator array can include a third plurality of actuators surrounding a third perimeter of the acoustic channel wall, wherein each of the third plurality of actuators extends from the acoustic channel wall toward the center of the acoustic channel.

In a tenth aspect, in addition to one or more of the preceding or following aspects, or in the alternative to some aspects, the first actuator includes a passive layer and wherein the piezoelectric layer extends less than 30% of a length of the passive layer. In an eleventh aspect, in addition to one or more of the preceding or following aspects, or in the alternative to some aspects, the first actuator can have a length of between about 100 and 500 microns.

In a twelfth aspect, in addition to one or more of the preceding or following aspects, or in the alternative to some aspects, further can include a substrate, wherein the first actuator array extends from the substrate.

In a thirteenth aspect, in addition to one or more of the preceding or following aspects, or in the alternative to some aspects, the substrate includes a flexible printed circuit board.

In a fourteenth aspect, in addition to one or more of the preceding or following aspects, or in the alternative to some aspects, the substrate can be disposed inside of the acoustic channel and forms a closed perimeter within the acoustic channel, wherein a first side of the substrate can be attached to the acoustic channel wall and each of the first plurality of actuators extends from a second side of the substrate.

In a fifteenth aspect, in addition to one or more of the preceding or following aspects, or in the alternative to some aspects, the second side of the substrate forms a substantially cylindrical cross section within the acoustic channel.

In a sixteenth aspect, in addition to one or more of the preceding or following aspects, or in the alternative to some aspects, the substrate forms an insert intercepting a portion of the acoustic channel wall, wherein each of the first plurality of actuators extends from a second side of the substrate.

In a seventeenth aspect, in addition to one or more of the preceding or following aspects, or in the alternative to some aspects, the second side of the substrate forms a substantially square cross section.

In an eighteenth aspect, an ear-worn device system can be included having an ear-worn device can be included having a device rechargeable battery, a housing defining an acoustic outlet, a receiver disposed within the housing, an acoustic channel having an acoustic channel wall formed by the housing, wherein the acoustic can be channel defined between the receiver and the acoustic outlet. The ear-worn device can include a first actuator array disposed within the acoustic channel, the first actuator array can include a first plurality of actuators surrounding a first perimeter of the acoustic channel wall, a power source electrically connected to the first actuator array, and an actuator control device configured to apply a control voltage from the power source to the first actuator array. Each of the first plurality of actuators extends from the acoustic channel wall toward a center of the acoustic channel. The actuator control device applies the control voltage from the power source to the first actuator array and wherein the first actuator moves in response to the application of the control voltage.

In a nineteenth aspect, in addition to one or more of the preceding or following aspects, or in the alternative to some aspects, further can include a case configured to charge the device rechargeable battery of the first ear-worn device. The case can include: a case charging structure for charging the device rechargeable battery of the ear-worn device, a case rechargeable battery, a case processor, and a case non-transitory computer memory, wherein the actuator control device applies the control voltage from the power source to the first actuator array after the ear-worn device can have been positioned in the case.

In a twentieth aspect, a method of moving debris from an ear-worn device ear-worn device, the ear-worn device can include a housing defining an acoustic outlet, a receiver disposed inside the housing, and an acoustic channel having an acoustic channel wall formed by the housing, wherein the acoustic can be channel defined between the receiver and the acoustic outlet. The method can include applying a first control voltage to a first actuator array disposed within the acoustic channel, the first actuator array can include a first plurality of actuators surrounding a first perimeter of the acoustic channel, wherein each of the first plurality of actuators moves in response to the application of the first control voltage. The method can include after applying the first control voltage, applying a second control voltage to a second actuator array disposed within the acoustic channel, the second actuator array can include a second plurality of actuators surrounding a second perimeter of the acoustic channel, wherein each of the second plurality of actuators moves in response to the application of the second control voltage.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of an ear-worn device in accordance with various embodiments herein.

FIG. 2 is a perspective view of a receiver assembly in accordance with various embodiments herein.

FIG. 3 is a cross-sectional view of the receiver assembly and earbud of FIG. 2 about section 3-3 in accordance with various embodiments herein.

FIG. 4 is a schematic view of an in-the-ear style custom ear-worn device in accordance with various embodiments herein.

FIG. 5 is a schematic view of an actuator in accordance with various embodiments herein.

FIG. 6 is a schematic view of an actuator in accordance with various embodiments herein.

FIG. 7 is a schematic view of an alternative configuration of an actuator in accordance with various embodiments herein.

FIG. 8 is a schematic view of an alternative configuration of an actuator in accordance with various embodiments herein.

FIG. 9 is a schematic view of an alternative configuration of an actuator in accordance with various embodiments herein.

FIG. 10 is a schematic view of an actuator array in accordance with various embodiments herein.

FIG. 11 is a schematic view of an actuator array in accordance with various embodiments herein.

FIG. 12 is a schematic view of an acoustic channel having multiple actuator arrays in accordance with various embodiments herein.

FIG. 13 is a schematic view illustrating an acoustic channel having multiple actuator arrays at three instances in time in accordance with various embodiments herein.

FIG. 14 is a schematic block diagram of an ear-worn device shown with various components of an ear-worn device in accordance with various embodiments herein.

FIG. 15 is a perspective view of a case in accordance with various embodiments herein.

FIG. 16 is a schematic block diagram of a case is shown with various components of a case in accordance with various embodiments herein.

While embodiments are susceptible to various modifications and alternative forms, specifics thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

One of the recurring problems with ear-worn devices is the accumulation of foreign matter interfering with the performance of the internal components. For instance, the performance of audio components placed in ear canal tends to suffer when foreign matter plugs the acoustic ports. Blockage of the acoustic ports can lead to dramatic change in acoustic impedance and an effective reduction in device output. For this reason, it is desirable for an ear-worn device to be able to proactively remove foreign material from its acoustic passages.

Embodiments herein relate to an ear-worn device having an active debris removal system. In various embodiments, the ear-worn device can include a housing defining an acoustic outlet and a receiver disposed within the housing. The ear-worn device can define an acoustic channel having an acoustic channel wall formed by the housing. The acoustic channel can be defined between the receiver and the acoustic outlet.

In various embodiments, the ear-worn device can include an actuator array disposed within the acoustic channel. The actuator array can include one or more actuators disposed within the acoustic channel and extending from the acoustic channel wall toward the center of the acoustic channel. Each actuator can include a piezoelectric layer. In various embodiments, the ear-worn device can include a power source electrically connected to the one or more actuators and an actuator control device configured to apply a control voltage from the power source to the one or more actuators. In various embodiments, the one or more actuators are configured to move in response to the application of the control voltage. In various embodiments, the one or more actuators are configured to remove debris from the acoustic channel.

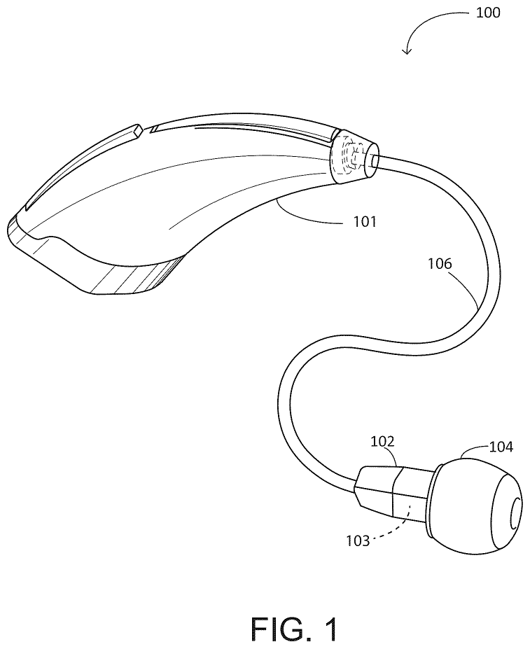

### Ear-Worn Device (FIG. 1)

Referring now to FIG. 1, a perspective view of an ear-worn device is shown in accordance with various embodiments herein. In various embodiments, the ear-worn device 100 can include an external unit 101, a receiver housing 102, an earbud 104 covering a portion of the receiver housing 102, and a cable 106 connecting the external unit 101 with the receiver housing 102. The external unit 101 may be worn outside of the ear canal, such as over the user's ear, behind the user's ear, clipped to a user's clothing, or many other locations.

An “ear-worn device” as used herein can include many different devices and combinations of devices that aid a person with impaired hearing by producing amplified sound. An “ear-worn device” can also refer to devices that produce optimized or processed sound for a user with normal hearing. The amplified, optimized or processed sound is output to a user, such as into the ear canal of a user.

Components of an ear-worn device herein can include a control circuit, digital signal processor (DSP), memory (such as non-volatile memory), power management circuitry, a data communications bus, one or more communication devices (e.g., a radio, a near-field magnetic induction device), one or more antennas, one or more microphones, and various sensors as described in greater detail below. More advanced hearing assistance devices can incorporate a long-range communication device, such as a Bluetooth® transceiver or other type of radio frequency (RF) transceiver. The ear-worn device can define a battery compartment into which a battery can be disposed to provide power to the device. These components can be divided between the external unit 101, other external devices, and the receiver housing 102. An external unit 101 can include input devices such as buttons or pads to control the ear-worn device.

The receiver housing 102 encloses a receiver 103, also referred to as a receiver speaker or a speaker. The receiver housing 102 is sized and shaped to fit within a user's ear canal. The ear-worn device 100 can be referred to as a receiver-in-canal (RIC) system. Sound is output from the receiver housing 102 to the user's ear canal. The cable 106 can include one or more electrical conductors and provide electrical communication between components inside of the external unit 101 and components inside of the receiver housing 102. The cable 106 provides an electrical signal from the external unit to drive the receiver to produce sound.

The ear-worn device 100 shown in FIG. 1 is a behind-the-ear (BTE) type device and thus the receiver is designed to be placed within the ear canal. However, it will be appreciated that many different form factors for ear-worn devices are contemplated herein. As such, ear-worn devices herein can include, but are not limited to, behind-the-ear (BTE), in—the ear (ITE), in-the-canal (ITC), invisible-in-canal (IIC), receiver-in-canal (RIC), receiver in-the-ear (RITE) and completely-in-the-canal (CIC) type ear-worn devices. Aspects of ear-worn devices and functions thereof are described in U.S. Pat. No. 9,848,273; U.S. Publ. patent application No. 20180317837; and U.S. Publ. patent application No. 20180343527, the content of all of which is herein incorporated by reference in their entirety.

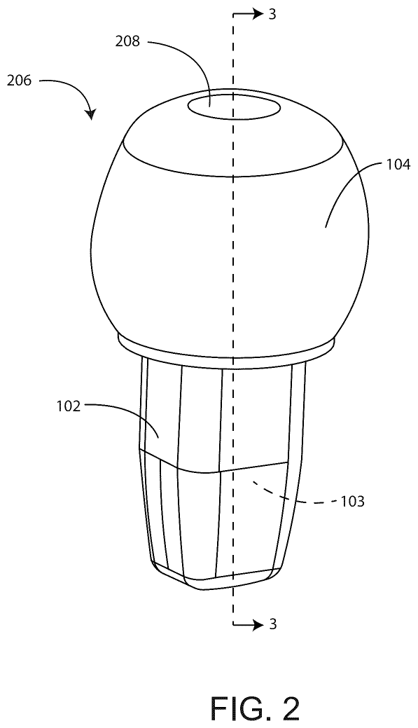

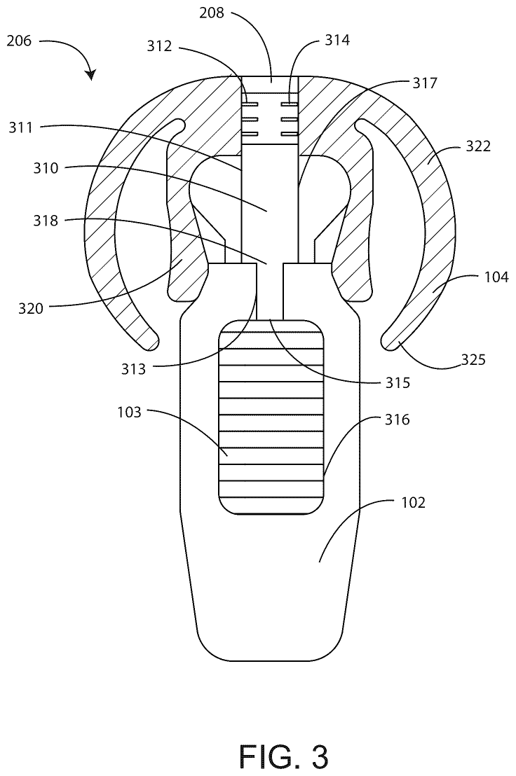

### Receiver Configuration (FIGS. 2-3)

Referring now to FIG. 2, a perspective view of a receiver assembly and earbud is shown in accordance with various embodiments herein. In various embodiments, an ear-worn device (such as the ear-worn device 100 of FIG. 1) can include a receiver assembly 206. The receiver assembly can be connected to an earbud 104. In various embodiments, the earbud 104 is configured to be removably attachable to the receiver assembly 206. The removable attachability of the earbud 104 from the receiver assembly 206 facilitates easy cleaning and replacement of the earbud 104. In various embodiments, the receiver assembly 206 can include a receiver housing 102 and a receiver 103 configured to fit within the receiver housing 102.

Referring now to FIG. 3, a cross-sectional view of the receiver assembly and earbud of FIG. 2 about section 3-3, is shown in accordance with various embodiments herein. In various embodiments, the receiver assembly can include a receiver 103 disposed within a housing cavity 316 of the receiver housing 102. A receiver, as defined herein, is any device that is configured to convert electrical signals into sounds, such as an electroacoustic transducer, speaker, loudspeaker, or the like. In the context of ear-worn devices, one or more microphones gather acoustic energy (sound) from the surrounding environment and convert the acoustic energy into electrical signals. In some embodiments, the electrical signals are then transmitted to an amplifier which increases the amplitude of the electric signals. The amplified electric signals are then transmitted to the receiver 103, which converts the received electric signals into sounds. The sounds are then transmitted to a user's ear via an acoustic outlet at the ear canal opening 208 of the ear-worn device 100. Any suitable type or types of receiver can be used in the ear-worn device 100 including, but not limited to armature receivers, moving coil receivers, or the like.

In the example of FIG. 3, sounds generated by the receiver 103 within the receiver housing 102 travel through an acoustic channel 310 that is defined by the receiver housing 102 and the earbud 104 and exits the receiver assembly 206 at an ear canal opening 208 of the earbud 104. In various embodiments, the acoustic channel 310 can define an acoustic channel wall 311. In the example of FIG. 3, a first portion of the acoustic channel wall 311 is formed by an inner surface 313 of the receiver housing 102. The first portion of the acoustic channel wall 311 can be defined between the receiver outlet 315 and a receiver opening 318 of the receiver housing 102. In the example of FIG. 3, a second portion of the acoustic channel wall 311 is formed by an inner surface 317 of the earbud 104. The second portion of the acoustic channel wall 311 can be defined between the receiver opening 318 and the ear canal opening 208 of the earbud 104.

In various embodiments, the earbud 104 includes an axial wall 320 that surrounds a portion of the receiver housing 102 when the earbud 104 is placed over a portion of the receiver housing 102. The axial wall 320 defines and surrounds at least a portion of the acoustic channel 310. In various embodiments, the earbud 104 also includes an outer dome 322. The outer dome can be connected to the axial wall 320 adjacent to the ear canal opening 208 of the earbud 104. In some embodiments, the outer dome 322 can be unconnected to the axial wall 320 at free end 325 to enhance the complaint fit of the earbud 104.

In various embodiments, the earbud 104 is made from a material and constructed so that it uniformly conforms to the ear canal and maintains a constant and comfortable radial pressure on the ear canal. In various examples, the earbud 104 is made of resilient material, such as silicone. In various examples, the earbud 104 is made of a flexible material. By flexible material, it is meant that a material is capable of bending easily without breaking. In various examples, the earbud is made of an elastomeric material. By “elastomeric material”, it is meant a material with viscoelasticity that is soft and deformable at ambient temperatures, such as rubber, silicone, and amorphous polymers. The flexibility and resilience of the material facilitates a seal of the earbud 104 to the receiver housing 102 over the acoustic channel 310.

In various embodiments, the ear canal opening 208 can provide an entry point for foreign matter into the ear-worn device. Foreign matter as defined herein is any matter other than air that can enter the ear-worn device and can include skin cells, dust, body oil, food, hairspray, ear wax, water, or the like. Performance of the audio components placed in ear canal (e.g., the receiver 103) tend to suffer when foreign matter plugs the acoustic ports (e.g., acoustic channel 310). In severe cases, foreign matter can collect on the acoustic channel wall 311 to the point that the acoustic channel 310 is almost entirely obstructed, resulting in dramatic change in acoustic impedance and effective reduction of device output. For this reason, ear worn devices often come with occlusion domes and protective grids for receivers that regular cleaning and replacement.

In various embodiments, the ear-worn device can be configured for active debris removal. An active debris removal system can be configured to actively remove foreign material from the acoustic passages(s) of an ear-worn device 100, meaning that foreign matter can be removed from the ear-worn device without human intervention. In the example of FIG. 3, the active debris removal system can include one or more actuator arrays 312 disposed in the acoustic channel 310. In various embodiments, each actuator array 312 can include at least one actuator 314 disposed within the acoustic channel 310 and extending from the acoustic channel wall 311 toward a center of the acoustic channel. In various embodiments, each actuator array 312 is configured to remove debris from the acoustic channel 310. In the example of FIG. 3, the one or more actuator arrays 312 are disposed adjacent to the ear canal opening 208 such that the actuators are configured to repel foreign matter from entering the acoustic channel 310.

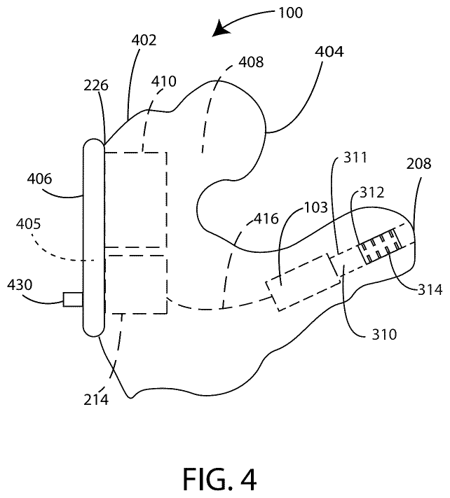

### Alternate Receiver Configuration (FIG. 4)

Referring now to FIG. 4, a schematic view of an in-the-ear style custom ear-worn device 100 is shown in accordance with various embodiments herein. The ear-worn device 100 can include an ear-worn device housing 402 formed by a shell 404 and a faceplate 406. The shell 404 is custom shaped to mate with the user's ear anatomy and defines a shell cavity 408 and a shell aperture 405 at the entrance to the shell cavity 408. The faceplate 406 is attached to the shell at the shell aperture 405 to enclose the shell cavity 408.

The ear-worn device housing 402 can define a battery compartment 410 in which a battery can be disposed to provide power to the device. The ear-worn device 100 can also include a receiver 103. The receiver 103 can include a component that converts electrical impulses into sound, such as an electroacoustic transducer, speaker, or loudspeaker. The ear-worn device housing 402 can also define a component compartment 214 that can contain electrical and other components including, but not limited to, a microphone, a processor, memory, various sensors, one or more communication devices, power management circuitry, and a control circuit. A cable 416 or connecting wire can include one or more electrical conductors and provide electrical communication between components inside of the component compartment 214 and components inside of the receiver 103.

In various embodiments, the shell 404 extends from an ear canal opening 208 to an aperture end 226. At the aperture end 226, the shell 404 defines a shell aperture 405 that is closed by the faceplate 406. The faceplate 406 is sealed to the shell 404. The faceplate 406 is shown in FIG. 2 only in a side view but can include many features and structures. A user input device 430 is shown as part of the faceplate in FIG. 2, and can be a button, lever, switch, dial, or other input device. The faceplate 406 may also include a battery door, a microphone opening, a pull handle, and other features.

In various embodiments, sounds generated by the receiver 103 travel through an acoustic channel 310 and exit the ear-worn device 100 at an ear canal opening 208. In various embodiments, the acoustic channel 310 can have an acoustic channel wall 311. In some embodiments, the acoustic channel wall 311 can be formed from a portion of the ear-worn device housing 402, such as during a molding process that forms the shell 404. Alternatively, the acoustic channel wall 311 can be formed from a structure separate from the ear-worn device housing 402, such as a one or more tubes inserted and attached to the shell 404. In one embodiment, one or more tubes made from a rubber or elastomer material can be used, such as a tube made from Viton™ fluoroelastomer materials made by DuPont, having a place of business in Wilmington, Delaware, United States.

In various embodiments, the ear canal opening 208 can provide an entry point for foreign material into the ear-worn device 100. In various embodiments, the ear-worn device 100 can be configured for active debris removal. In the example of FIG. 4, the active debris removal system can include one or more actuator arrays 312 disposed within the acoustic channel 310. In various embodiments, each actuator array 312 can include at least one actuator 314 disposed within the acoustic channel 310 and extending from the acoustic channel wall 311 toward a center of the acoustic channel. In various embodiments, each actuator array 312 is configured to remove debris from the acoustic channel 310. In the example of FIG. 4, the one or more actuator arrays 312 are disposed adjacent to the ear canal opening 208 such that the actuators 314 are configured to deflect and replace foreign matter from entering the acoustic channel 310. The configuration of the actuators will now be described in detail herein.

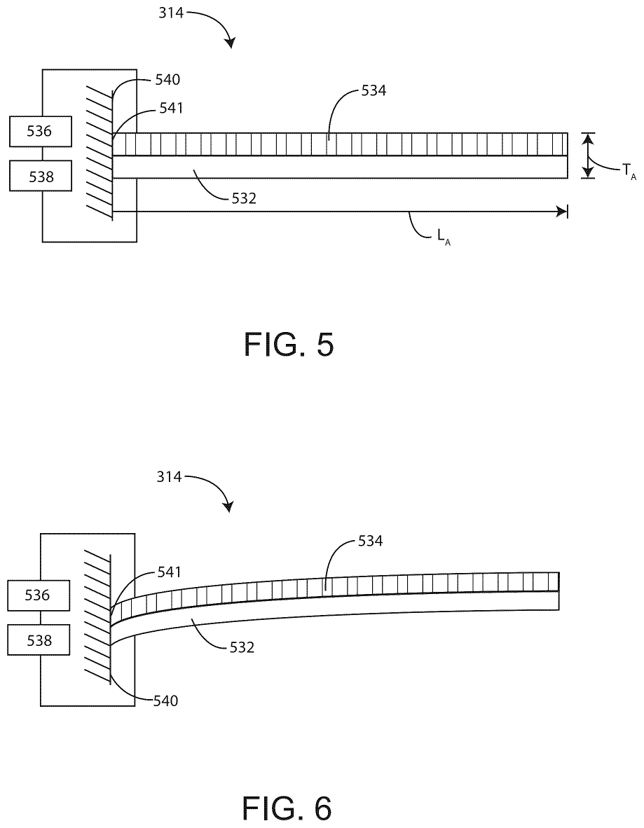

### Actuator Configuration (FIGS. 5-9)

In various embodiments, the actuator array 312 can include at least one actuator 314. In various embodiments, the actuator 314 can be a piezoelectric actuator. A piezoelectric actuator, as defined herein, is a type of electromechanical device that utilizes the piezoelectric effect to generate motion or force. The piezoelectric effect is a property of certain materials (such as piezoelectric ceramics, crystals, or polymers) that allows them to generate an electric charge in response to mechanical deformation (stress) or, conversely, to undergo mechanical deformation in response to an applied electric field. Piezoelectric actuators work by applying an electric field to the piezoelectric material, causing it to change shape or deform. This deformation can be harnessed for various purposes, such as precise positioning, vibration control, or generating small-scale mechanical movements. In alternate embodiments, the actuator(s) 314 of actuator array 312 can be any other suitable type of actuator including, but not limited to electromagnetic actuators, or the like. Exemplary representations of an actuator 314 are depicted by FIGS. 5-8:

Referring now to FIG. 5, a schematic view of an actuator is shown in accordance with various embodiments herein. In various embodiments, the actuator 314 can include a piezoelectric layer 534 and a passive layer 532. The piezoelectric layer 534 can be permanently bonded to the passive layer 532 by any suitable means such as welding, adhesives, or the like. The piezoelectric layer 534 and the passive layer 532 can be mounted to a substrate 540 at a fixed end 541. The actuator 314 can further include a power source 536 electrically connected to the piezoelectric layer 534. Any suitable power source can be used such as a piezoelectric driver, or the like. The actuator 314 can further include an actuator control device 538 configured to apply a control voltage from the power source 536 to the piezoelectric layer 534.

In various embodiments, the piezoelectric layer 534 can be formed from one or more piezoelectric materials including, any suitable piezoelectric ceramic (e.g., PZT-5H), piezoelectric crystal, or the like. In various embodiments, the passive layer 532 can be formed from any suitable non-piezoelectric material. The passive layer 532 should be sufficiently rigid to provide support to the piezoelectric layer 534, but sufficiently ductile to deflect along with the piezoelectric layer 534 when a control voltage is applied. In various embodiments, the passive layer 532 can be formed from any suitable material or materials including, but not limited to metals, polymers, or the like.

In various embodiments, the actuator 314 is configured to deflect in response to a control voltage applied by the power source 536. Referring now to FIG. 6, a schematic view of the actuator of FIG. 5 in a deflected position is shown in accordance with various embodiments herein. In various embodiments, the actuator control device 538 commanding the power source 536 to apply the control voltage to the piezoelectric layer 534 causes the piezoelectric layer 534 to deform. In some embodiments, the piezoelectric layer 534 expands when the control voltage is applied. In some embodiments, the piezoelectric layer 534 contracts when the control voltage is applied. Due to the piezoelectric layer 534 and passive layer 532 being mounted to the substrate 540 at fixed end 541, the deformation of the piezoelectric layer 534 induces a bending displacement in the piezoelectric land passive layers.

In the example of FIGS. 5-6, the actuator has a unimorph configuration. Unimorph actuators as defined herein include a single piezoelectric layer 534 bonded to a passive layer 532. However, other configurations of actuator are possible including, but not limited to bimorph actuators.

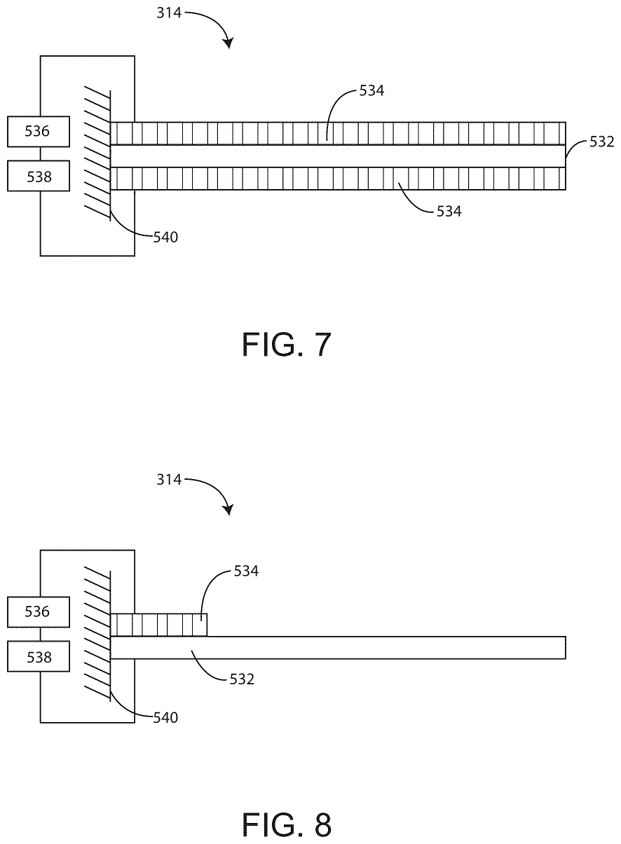

Referring now to FIG. 7, a schematic view of an alternative configuration of an actuator is shown in accordance with various embodiments herein. The actuator of FIG. 7 is an example of a bimorph actuator. A bimorph actuator is a cantilever used for actuation or sensing which consists of two active (piezoelectric) layers. Bimorph actuators can also have a passive (substrate) layer between the two active layers. In actuator applications, one active layer can be configured to contract while and the other active layer expands when a control voltage is applied, thus the bimorph bends.

In the example of FIG. 7, the actuator 314 can include two piezoelectric layers 534 bonded to either side of a passive layer 532. The piezoelectric layers 534 and the passive layer 532 can be mounted to a substrate 540 at a fixed end 541. The actuator 314 can further include a power source 536 electrically connected to the piezoelectric layers 534. The actuator 314 can further include an actuator control device 538 configured to apply a control voltage from the power source 536 to the piezoelectric layers 534.

In the embodiments of FIGS. 5-7, the passive layer 532 is substantially the same length as the piezoelectric layer(s) 534. In alternate configurations, the passive layer 532 can be shorter than the piezoelectric layer(s) 534. Such a configuration can reduce the material requirements for the actuator while still achieving the desired deflection effect.

Referring now to FIG. 8, a schematic view of an alternative configuration of an actuator is shown in accordance with various embodiments herein. The actuator 314 can have the same configuration as the actuator of FIGS. 5-6, but the passive layer 532 is shorter in length than the piezoelectric layer(s) 534.

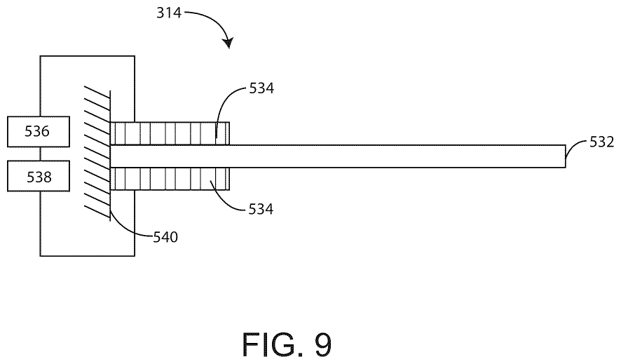

Referring now to FIG. 9, a schematic view of an alternative configuration of an actuator is shown in accordance with various embodiments herein. The actuator 314 can have the same configuration as the actuator of FIG. 7, but the passive layers 532 are shorter in length than the piezoelectric layer(s) 534.

In some embodiments, the length of the piezoelectric layer (or layers) 534 can be greater than or equal to 10%, 15%, 20%, 25%, or 30% of the length of the passive layer 532. In some embodiments, the length of the piezoelectric layer 534 can be less than or equal to 90%, 80%, 65%, 50%, or 30% of the length of the passive layer 532. In some embodiments, the length of the piezoelectric layer 534 can fall within a range of 10% to 90%, or 1% to 80%, or 20% to 65%, or 25% to 50%, or can be about 30% of the length of the passive layer 532.

In various embodiments, the actuator 314 must be a suitable length to fit within the acoustic channel 310 of an ear-worn device 100 and to deflect foreign material from the acoustic channel. Referring back to FIG. 5, the length L_{A} of the actuator 314 as defined herein is the length of the longer of the passive layer 532 and the piezoelectric layer 534. In some embodiments, the actuator length L_{A} can be greater than or equal to 50, 60, 70, 80, 90, or 100 microns. In some embodiments, the actuator length L_{A} can be less than or equal to 500, 420, 340, 260, 180, or 100 microns. In some embodiments, the actuator length L_{A} can fall within a range of 50 to 500 microns, or 60 to 420 microns, or 70 to 340 microns, or 80 to 260 microns, or 90 to 180 microns, or can be about 100 microns.

In various embodiments, the actuator 314 must be thin enough to not permanently deform when deflected by the control voltage, yet thick enough to have the robustness to repel foreign matter from the acoustic channel 310. Referring back to FIG. 5, the thickness T_{A} of the actuator 314 as defined herein is the combined thickness of passive layer 532 and the piezoelectric layer 534. In some embodiments, the actuator thickness T_{A} can be greater than or equal to 1, 2, 3, 4, or 5 microns. In some embodiments, the actuator thickness T_{A} can be less than or equal to 20, 16, 12, 9, or 5 microns. In some embodiments, the actuator thickness T_{A} can fall within a range of 1 to 20 microns, or 2 to 16 microns, or 3 to 12 microns, or 4 to 9 microns, or can be about 5 microns.

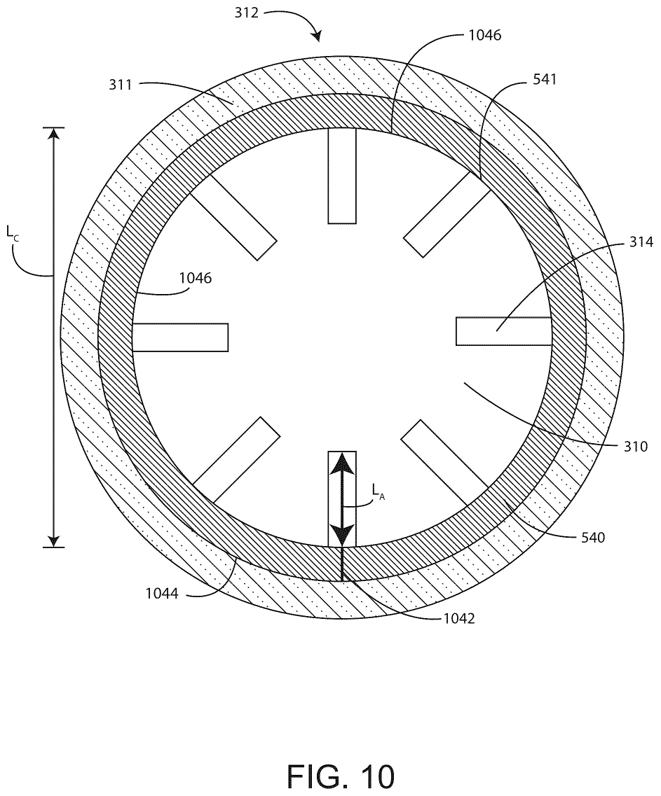

### Actuator Arrays (FIGS. 10-12)

Referring now to FIG. 10, a schematic view of an actuator array is shown in accordance with various embodiments herein. In various embodiments, the actuator array 312 is disposed within the acoustic channel 310 of an ear-worn device 100. The actuator array can include at least one actuator 314 disposed within the acoustic channel 310 and extending from the acoustic channel wall 311 toward the center of the acoustic channel. Each actuator can include at least one piezoelectric layer 534 bonded to at least one passive layer 532 as described in detail in the context of FIGS. 5-9. In various embodiments, the actuator array 312 can include a power source (such as power source 536) electrically connected to each actuator 314. In various embodiments, the actuator array 312 can include an actuator control device (such as actuator control device 538) that is configured to apply a control voltage from the power source 536 to each actuator 314 in the actuator array 312 such that the actuators 314 in actuator array 312 move in response to the application of the control voltage.

In various embodiments, the actuator array 312 can have any suitable number of actuators 314. In some embodiments, the number of actuators 314 in actuator array 312 can be greater than or equal to 1, 3, 6, 8, or 10 actuators. In some embodiments, the number of actuators 314 in actuator array 312 can be less than or equal to 30, 25, 20, 15, or 10 actuators. In some embodiments, the number of actuators 314 in actuator array 312 can fall within a range of 1 to 30 actuators, or 3 to 25 actuators, or 6 to 20 actuators, or 8 to 15 actuators, or can be about 10 actuators.

In various embodiments, the length of the actuators 314 in actuator array 312 should be long enough to repel foreign matter from the acoustic channel 310, but short enough to not obstruct sounds from propagating through the acoustic channel. In various embodiments, the length of each actuator L_{A} can span a faction of the open length of the acoustic channel L_{C}. In some embodiments, the ratio of the lengths L_{A}/L_{C} can be greater than or equal to 0.05, 0.09, 0.12, 0.16, or 0.20. In some embodiments, the ratio of the lengths L_{A}/L_{C} can be less than or equal to 0.45, 0.39, 0.32, 0.26, or 0.20. In some embodiments, the ratio of the lengths L_{A}/L_{C} can fall within a range of 0.05 to 0.45, or 0.09 to 0.39, or 0.12 to 0.32, or 0.16 to 0.26, or can be about 0.20.

In the example of FIG. 10, each of the plurality of actuators 314 of actuator array 312 are approximately the same length L_{A}. However, in alternative configurations it is possible for an actuator array 312 to include a plurality of actuators 314 having two or more different lengths. For example, an actuator array 312 can contain actuators 314 of at least two different lengths and alternate between shorter actuators and longer actuators around the perimeter of the acoustic channel 310. Moreover, while the actuators 314 depicted in the figures are rectangular in cross-sectional shape, any other suitable shape or shapes of actuator may be used in an ear-worn device, such as triangular (e.g., wider at the fixed end 541 and narrower towards the tip), or the like.

In various embodiments, the actuator array includes a substrate 540. The substrate 540 can be a flexible strip such as a flexible printed circuit board, or the like. In various embodiments, the substrate 540 is configured to be disposed inside of the acoustic channel 310 with a first side 1044 of the substrate 540 attached to the acoustic channel wall 311 and a second side 1046 of the substrate facing inwards towards the acoustic channel 310. In various embodiments, the first side 1044 of the substrate 540 is configured to be attached to the acoustic channel wall 311 by any suitable means including, but not limited to welding, adhesives, or the like. In various embodiments, a fixed end 541 of each of the one or more actuators 314 is attached to the second side 1046 of the substrate 540.

In various embodiments, substrate 540 is configured to form a closed perimeter that forms a portion of the acoustic channel 310. In some embodiments, substrate 540 is manufactured in an annular shape having an outer diameter that is approximately equal to the diameter of the acoustic channel 310. In alternative embodiments, substrate 540 is manufactured as a strip having a length that is approximately equal to the diameter of the acoustic channel 310. The strip can then be joined at seam 1042 to form a ring configured to be placed within the acoustic channel 310. In the example of FIG. 10, the second side 1046 of the substrate 540 forms a substantially cylindrical cross section within the acoustic channel 310. Alternatively, the actuator array 312 can be manufactured to conform to any suitable shape of acoustic channel.

In various embodiments, the one or more actuators 314 are mounted to the second side 1046 of the substrate 540 at fixed end 541 and are configured to extend from the second side of the substrate to the center of the acoustic channel 310. The substrate 540 can be a printed circuit board that is configured to electrically connect each actuator 314 of the actuator array 312 to one or more electrical components such as power source 536 and actuator control device 538. In some embodiments, each actuator 314 of the actuator array 312 is manufactured directly onto the substrate 540. In some embodiments, each actuator 314 of the actuator array 312 is manufactured separately from the substrate 540 and is subsequently joined to the substrate by any suitable means including, but not limited to welding, adhesives, or the like.

In various embodiments, each of the one or more actuators 314 of actuator array 312 are configured to deflect in response to a control voltage applied by the power source 536. In some embodiments, each of the one or more actuators 314 of actuator array 312 are configured to deflect in the same direction, such as towards the ear canal opening 208 of the acoustic channel 310, such that the actuators are configured to repel foreign matter from the acoustic channel. In some embodiments, the actuator control device 538 is configured to apply the control voltage to each of the actuators 314 simultaneously such that all the actuators deflect at approximately the same time. In some embodiments, the actuator control device 538 is configured to apply the control voltage to each of the actuators 314 individually or in groups such that some actuators deflect at different times than others.

In the example of FIG. 10, the actuator array 312 is bonded to the acoustic channel wall 311. However, in alternate configurations, the actuator array 312 can take the form of an insert intercepting a portion of the acoustic channel wall 311. In various embodiments, two or more tube portions are used to form the acoustic channel wall 311, and an actuator array 312 is placed between two neighboring tube portions.

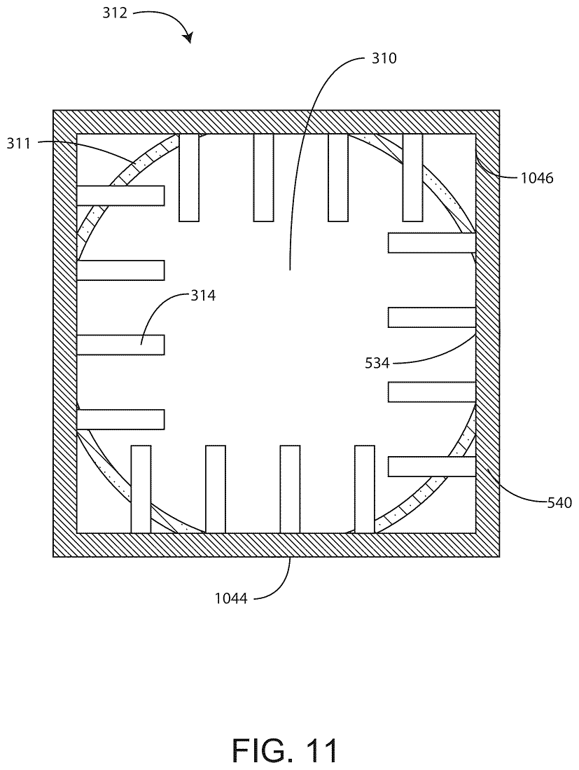

Referring now to FIG. 11, a schematic view of an actuator array is shown in accordance with various embodiments herein. In various embodiments, actuator array 312 can form a portion of the acoustic channel 310. In the example of FIG. 11, the substrate 540 forms an insert intercepting a portion of the acoustic channel wall 311. The actuator array 312 can include at least one actuator 314, such as the actuators described in the context of FIGS. 5-10. In various embodiments, the actuator array 312 can include a power source (such as power source 536) electrically connected to each actuator 314. In various embodiments, the actuator array 312 can include an actuator control device (such as actuator control device 538) that configured to apply a control voltage from the power source to each actuator in the actuator array such that the actuators 314 in actuator array 312 move in response to the application of the control voltage.

In various embodiments, the substrate 540 can be a flexible strip such as a flexible printed circuit board, or the like. In some embodiments, the substrate 540 may be reinforced with an additional rigid layer such that the substrate maintains its shape within the acoustic channel. Substrate 540 is configured to be an insert intercepting a portion of the acoustic channel wall 311. For instance, the ear-worn device 100 can be manufactured with a gap in the acoustic channel wall 311 and the substrate 540 can be sized to fill the gap. In various embodiments, the substrate 540 is configured to be joined to the gap in the acoustic channel wall by any suitable means including, but not limited to welding, adhesives, or the like. In various embodiments, two or more tube portions are used to form the acoustic channel wall 311, and the substrate 540 of the actuator array 312 is placed between two neighboring tube portions.

In the example of FIG. 11, the second side 1046 of substrate 540 forms a substantially square cross section. However, the substrate can have any other suitable cross-sectional shape, such as circular, or the like. In various embodiments, the actuators 314 are mounted to the second side 1046 of the substrate 540 and are configured to extend from the second side of the substrate towards the center of the acoustic channel 310. The substrate 540 can be a printed circuit board that is configured to electrically connect each actuator 314 of the actuator array 312 to other electrical components such as power source 536 and actuator control device 538.

In various embodiments, each of the one or more actuators 314 of actuator array 312 are configured to deflect in response to a control voltage applied by the power source 536. In some embodiments, each of the one or more actuators 314 are configured to deflect in the same direction, such as towards the ear canal opening 208 of the acoustic channel 310, such that the actuators are configured to repel foreign matter from the acoustic channel. In some embodiments, the actuator control device 538 is configured to apply the control voltage to each of the actuators simultaneously such that all the actuators deflect at approximately the same time. In some embodiments, the actuator control device 538 is configured to apply the control voltage to each of the actuators individually or in groups such that some actuators deflect at different times than others. For example, the actuator control device 538 can be configured to apply the control voltage to the actuators on the horizontal sides of the substrate at a first time and to apply the control voltage to the actuators on the vertical sides of the substrate at a second time.

In the example of FIG. 11, each of the plurality of actuators 314 of actuator array 312 are approximately the same length. However, in alternative configurations it is possible for an actuator array 312 to include a plurality of actuators 314 having two or more different lengths. For example, an actuator array 312 can contain actuators 314 of at least two different lengths with shorter actuators towards the corners of the substrate and longer actuators towards the center of each side of the substrate.

While the examples of FIGS. 10-11 depict a singular actuator array 312 disposed within an acoustic channel 310, in various embodiments, it can be advantageous for an ear wearable device 100 to include multiple actuator arrays.

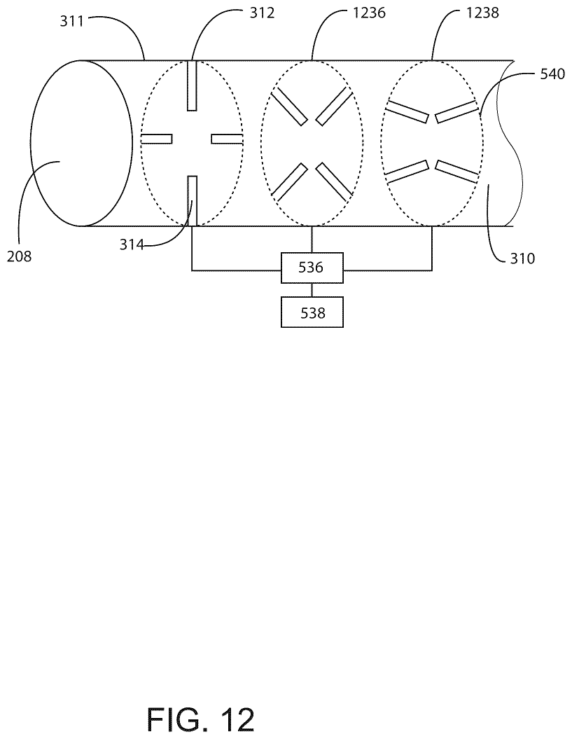

Referring now to FIG. 12, a schematic view of an acoustic channel having multiple actuator arrays is shown in accordance with various embodiments herein. In various embodiments, the acoustic channel 310 can have an acoustic channel wall 311 defined between the ear canal opening 208 and the receiver (not shown in the view, but on the opposite side of the acoustic channel to the ear canal opening). In various embodiments, the acoustic channel 310 can define a plurality actuator arrays 312 disposed within the acoustic channel (e.g., the actuator array of FIG. 10) and/or intercepting a portion of the acoustic channel wall 311 (e.g., the actuator array of FIG. 11).

In the example of FIG. 12, the acoustic channel 310 includes a first actuator array 312, a second actuator array 1236, and a third actuator array 1238 distributed throughout the acoustic channel 310 between the ear canal opening 208 and the receiver. In various embodiments, the acoustic channel 310 can include any suitable number of actuator arrays 312. In some embodiments, the number of actuator arrays 312 within the acoustic channel 310 can be greater than or equal to 1, 3, 5, 7, 9, or 10 arrays, or can be an amount falling within a range between any of the foregoing.

In various embodiments, each of the actuator arrays 312, 1236, 1238 can include one or more actuators 314 configured to surround the acoustic channel wall 311. Each of the actuators 314 are configured to extend from the acoustic channel wall 311 toward the center of the acoustic channel 310. Each of the actuator arrays 312, 1236, 1238 can further include a substrate 540, such as a flexible printed circuit board, or the like. Each substrate 540 can be configured to electrically connect the actuators 314 of each of the actuator arrays 312, 1236, 1238 to the power source 536 and actuator control device 538. In the example of FIG. 12, the power source 536 and actuator control device 538 are electrically connected to all three of the actuator arrays 312, 1236, 1238. In alternate configurations, actuator arrays 312, 1236, 1238 can each have their own separate power source 536 and actuator control device 538 to apply the control voltage to their respective actuators 314.

In various embodiments and as seen in FIG. 12, each of the plurality of actuators 314 of the first actuator array 312 have an angular offset from (in this case rotated approximately 30° with respect to) each of the plurality of actuators 314 of the second actuator array 1236 and each of each of the plurality of actuators 314 of the second actuator array 1236 have an angular offset from (in this case rotated approximately 30° with respect to) each of the plurality of actuators 314 of the third actuator array 1238. In another example, an ear-worn device 100 can include two or more actuator arrays with each subsequent actuator array 312 rotated approximately 10° with respect to the previous actuator array.

Such a configuration can prevent foreign matter from passing through gaps between the actuators 314 and advancing further into the acoustic channel 310. Such a configuration can also induce a spiral motion of the foreign matter as it is deflected from the acoustic channel 310 by the actuator arrays 312, 1236, 1238. A control scheme for removing debris from the acoustic channel 310 using a plurality of actuator arrays 312 will now be described in detail herein.

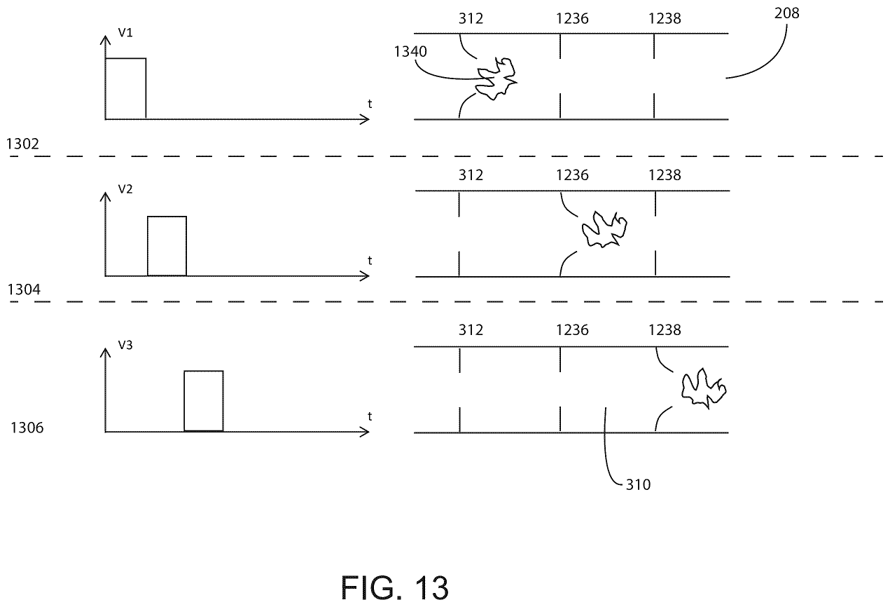

### Actuator Control Scheme (FIG. 13)

Referring now to FIG. 13, a schematic view illustrating an acoustic channel having multiple actuator arrays at three instances in time is shown in accordance with various embodiments herein. FIG. 13 depicts a control scheme for removing debris from the acoustic channel 310 with a plurality of actuator arrays 312, 1236, 1238 at a first time 1302, second time 1304, and third time 1306.

For each instance of time 1302, 1304, 1306, a simplified view of an acoustic channel 310 is shown. The acoustic channel 310 can be defined between the ear canal opening 208 and the receiver (not shown in the view, but on the opposite side of the acoustic channel to the ear canal opening) and can include all the features shown and described in the previous views. In the example of FIG. 13, the acoustic channel 310 includes a first actuator array 312, second actuator array 1236, and third actuator array 1238 distributed throughout the acoustic channel 310 between the ear canal opening 208 and the receiver. However, the following protocol can apply for any suitable number of actuator arrays 312 such as two actuator arrays or three or more actuator arrays.

In various embodiments, each of the actuator arrays 312, 1236, 1238 can be connected to a power source 536 and an actuator control device 538. In various embodiments, the actuator control device 538 is configured to apply a control voltage to each of the actuator arrays 312, 1236, 1238. In some embodiments, the actuator control device 538 is configured to apply the control voltage to each of the actuator arrays 312, 1236, 1238 simultaneously. Alternatively, the actuator control device 538 is configured to apply a control voltage from the power source 536 to first actuator array 312 at first time 1302, apply a control voltage from the power source to second actuator array 1236 at second time 1304, and apply a control voltage from the power source to third actuator array at third time 1306.

In various embodiments, the sequential operation of the actuator arrays 312, 1236, 1238 is configured to remove foreign matter 1340 from the acoustic channel 310 of an ear-worn device 100 in a debris removal protocol. In the example of FIG. 13, at first time 1302, the foreign matter 1340 is deflected by the first actuator array 312 towards the second actuator array 1236, at second time 1304, the foreign matter 1340 is deflected by the second actuator array 1236 towards the third actuator array 1238, and at third time 1306, the foreign matter 1340 is deflected by the third actuator array 1238 such that the foreign matter exits the acoustic channel 310 at ear canal opening 208.

In various embodiments, the actuator arrays 312, 1236, 1238 are each actuated sequentially with a set time delay between each actuation. In one example, the actuator control device 538 is configured to apply a control voltage from the power source 536 to the second actuator array 1236 (at second time 1304) at a set time delay after applying the control voltage from the power source to the first actuator array 312 (at first time 1302).

In some embodiments, the time delay can be greater than or equal to 0.05 seconds, 0.12 seconds, 0.18 seconds, or 0.25 seconds. In some embodiments, the time delay can be less than or equal to 1.00 seconds, 0.75 seconds, 0.50 seconds, or 0.25 seconds. In some embodiments, the time delay can fall within a range of 0.05 seconds to 1.00 second, or 0.12 seconds to 0.75 seconds, or 0.18 seconds to 0.50 seconds, or can be about 0.25 seconds.

In the same example, the actuator control device 538 is configured to apply a control voltage from the power source 536 to the third actuator array 1238 (at third time 1306) at a set time delay after applying the control voltage from the power source to the second actuator array 1236 (at second time 1304). In some embodiments, the time delay can be greater than or equal to 0.05 seconds, 0.12 seconds, 0.18 seconds, or 0.25 seconds. In some embodiments, the time delay can be less than or equal to 1.00 seconds, 0.75 seconds, 0.50 seconds, or 0.25 seconds. In some embodiments, the time delay can fall within a range of 0.05 seconds to 1.00 second, or 0.12 seconds to 0.75 seconds, or 0.18 seconds to 0.50 seconds, or can be about 0.25 seconds.

In various embodiments, the debris removal protocol can include applying a control voltage to each actuator array 312, 1236, 1238 a predetermined number of times. In some embodiments, the actuator control device 538 is configured to apply the control voltage to each actuator array once. Alternatively, the actuator control device 538 is configured cycle through applying the control voltage to each actuator array for a predetermined number of cycles. For instance, after the third actuator array 1238 has been actuated, the actuator control device 538 is configured to cycle back to applying the control voltage to the first actuator array 312. In some embodiments, the number of cycles for a given debris removal protocol can be greater than or equal to 1 cycle, 3 cycles, 5 cycles, 7 cycles, 9 cycles, or 10 cycles, or can be an amount falling within a range between any of the foregoing.

In some embodiments, the actuator control device 538 is configured cycle through applying the control voltage to each actuator array for a predetermined time duration. In some embodiments, the predetermined time duration for a given debris removal protocol can be greater than or equal to 5 seconds, 9 seconds, 12 seconds, 16 seconds, or 20 seconds. In some embodiments, the predetermined time duration can be less than or equal to 90 seconds, 70 seconds, 55 seconds, 40 seconds, or 20 seconds. In some embodiments, the predetermined time duration can fall within a range of 5 seconds to 90 seconds, or 9 seconds to 70 seconds, or 12 seconds to 55 seconds, or 16 seconds to 40 seconds, or can be about 20 seconds.

In various embodiments, the debris removal protocol can be executed at predetermined time increments. For instance, debris removal protocol can be executed every few hours. In some embodiments, the predetermined time increment can be greater than or equal to 1, 2, 4, 5, or 6 hours. In some embodiments, the predetermined time increment can be less than or equal to 24, 20, 15, 10, or 6 hours. In some embodiments, the predetermined time increment can fall within a range of 1 to 24 hours, or 2 to 20 hours, or 4 to 15 hours, or 5 to 10 hours, or can be about 6 hours.

In some embodiments, the predetermined time increment can remain constant.

Alternatively, the predetermined time increment can be altered based on a number of factors including, but not limited to time of day, user input, or the like. For instance, an ear-worn device user may program the ear-worn device 100 to only execute the debris removal protocol during nighttime hours when the ear-worn device user is asleep and not wearing the ear-worn device. In another example, an ear-worn device user may program the ear-worn device 100 to execute the debris removal protocol more frequently (by shortening the predetermined time increment) during the daytime when the ear-worn device 100 is in use and accumulating foreign matter.

In various embodiments, the debris removal protocol can be executed each time a particular event or events are detected by the ear-worn device 100. In various embodiments, the debris removal protocol can be executed when any of the following are detected by the ear-worn device 100 including, but not limited to: the ear-worn device being placed in the ear of a user, the ear-worn device being removed from the ear of a user, the ear-worn device being placed in a case, the ear word device charging, the user commanding the ear-worn device to execute the debris removal protocol, and when debris being detected in the acoustic channel 310 of the ear-worn device.

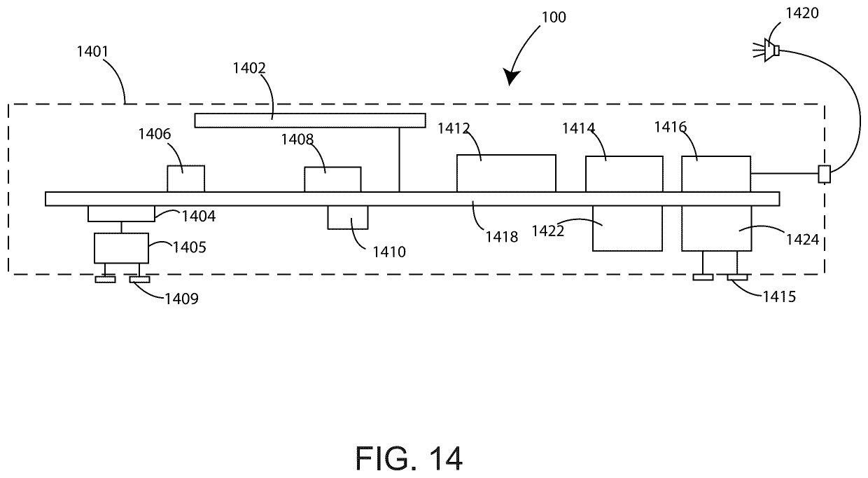

### Ear-Worn Device Components (FIG. 14)

Referring now to FIG. 14, a schematic block diagram of an ear-worn device is shown with various components of an ear-worn device in accordance with various embodiments herein. The block diagram of FIG. 14 represents a generic ear-worn device for purposes of illustration. It will be appreciated that ear-worn devices herein can include a greater or lesser number of components than that shown in FIG. 14. The ear-worn device 100 shown in FIG. 14 includes several components electrically connected to a flexible mother circuit 1418 which is disposed within housing 1401. A power supply circuit 1404 can include a battery 1405 and can be electrically connected to the flexible mother circuit 1418 and provides power to the various components of the ear-worn device 100. In some examples, the power supply circuit 1404 can include power supply that is different than a battery and which is electrically connected to the flexible mother circuit 1418 and provides power to the various components of the ear-worn device 100. In some embodiments the battery 1405 is rechargeable and can be charged via ear-worn device charging contacts 1409.

One or more microphones 1406 are operatively connected to the flexible mother circuit 1418, which provides electrical communication between the microphones 1406 and a digital signal processor (DSP) 1412. Among other components, the DSP 1412 incorporates or is coupled to audio signal processing circuitry configured to implement various functions described herein. A sensor package 1414 can be coupled to the DSP 1412 via the flexible mother circuit 1418. The sensor package 1414 can include one or more different specific types of sensors. One or more user switches 1410 (e.g., on/off, volume, mic directional settings) can be operatively coupled to the DSP 1412 via the flexible mother circuit 1418.

An audio output device 1416 is operatively connected to the DSP 1412 via the flexible mother circuit 1418. In some embodiments, the audio output device 1416 comprises a speaker (coupled to an amplifier). In other embodiments, the audio output device 1416 comprises an amplifier coupled to an external receiver 1420 adapted for positioning within an ear of a wearer. The external receiver 1420 can include an electroacoustic transducer, speaker, or loudspeaker. The ear-worn device 100 may incorporate a wireless communication component 1408 coupled to the flexible mother circuit 1418 and to an antenna 1402 directly or indirectly via the flexible mother circuit 1418. The wireless communication component 1408 can be a BLUETOOTH® transceiver, such as a BLE (BLUETOOTH® low energy) transceiver or other transceiver (e.g., an IEEE 802.11 compliant device).

In various embodiments, the ear-worn device 100 can also include a control circuit 1424 and a memory storage device 1422. The control circuit 1424 can be in electrical communication with other components of the device. The control circuit 1424 can execute various operations, such as those described herein. In some embodiments, the control circuit 1424 is electrically connected to the input device 1415, such that the control circuit can process signals generated by the suer input. Control circuit 1424 can include various components including, but not limited to, a microprocessor, a microcontroller, an FPGA (field-programmable gate array) processing device, an ASIC (application specific integrated circuit), or the like. The memory storage device 1422 can include both volatile and non-volatile memory. The memory storage device 1422 can include ROM, RAM, flash memory, EEPROM, SSD devices, NAND chips, and the like. The memory storage device 1422 can be used to store data from sensors as described herein and/or processed data generated using data from sensors as described herein.

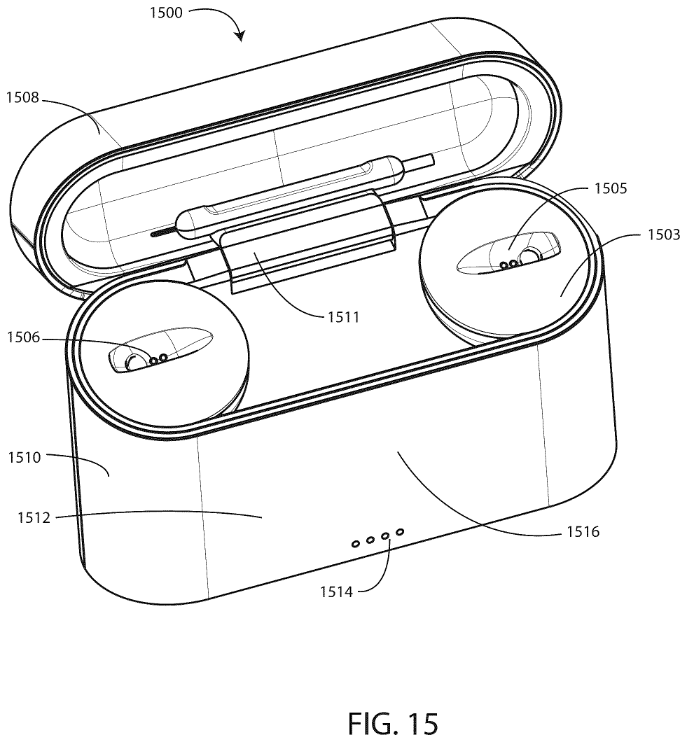

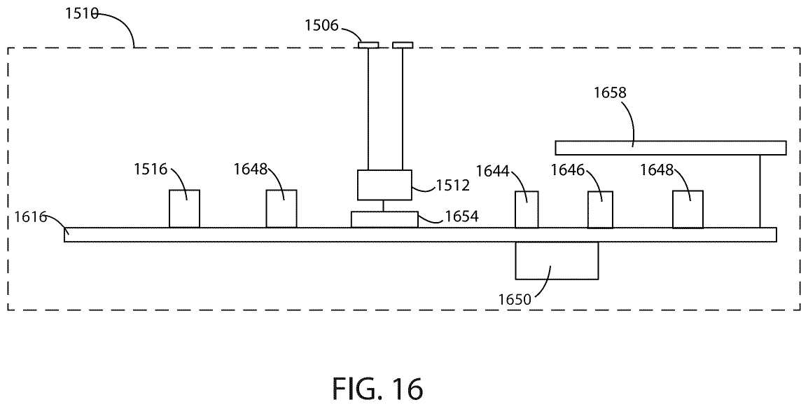

### Charging Case (FIGS. 15-16)

Referring now to FIG. 15, a perspective view of a case is shown in accordance with various embodiments herein. Embodiments of the case 1500 are directed to storing, protecting, and charging ear-worn device(s) 100 contained within the case. In various embodiments, the case 1500 may be configured to move between an open position and a closed position. The case may be sized to be easily held in a human hand, easily held in a typical pocket of clothing, and easily transported. As a result of the ease of transportation, a user is more likely to bring the case along with the user when away from home or even within the home. A safe place for storing the ear-worn devices and the ability to charge the hearing aids is therefore more likely to be close at hand to the user. In various embodiments, the case may be opened and closed with a single human hand.

In various embodiments, the case 1500 can have an interior top surface 1503 and one or more indentations 1505 defined in the interior top surface 1503. Each indentation 1505 is configured to receive an ear-worn device 100. Each indentation 1505 can include a case charging structure 1506 for charging a rechargeable battery 1405 of an ear-worn device via ear-worn device charging contacts 1409.

The case can have a case main body 1510 and a lid 1508. The case main body 1510 may further include a case battery 1512 and case electronics configured to charge one or more ear-worn devices 100 among other optional functions. The case main body 1510 may be connected to the lid 1508 by a hinge 1511 such that the lid can move the case between an open and closed position. 1514

In various embodiments, the case 1500 may include case display 1514 to provide a visual indicator regarding the status of components within the case 1500. For example, the case display 1514 may communicate the power level/status of the ear-worn devices or the case battery 1512 contained within the case 1500. Alternatively, or in addition, the display 1514 can include a screen, touch screen, or other type of display device.

In various examples, the case 1500 may be configured or adapted such that the ear-worn devices 100 contained within the case are charging when the case is in a closed position, and, for example, not charging when the case is in the open position. Specifically, the case may include one or more contact points that interact with one another when the case is in the closed position to charge the ear-worn devices. As such, a user knows that the ear-worn devices contained within the case are charging when the case is in a closed position. In one or more embodiments, the case may also be configured or adapted such that the ear-worn devices contained within the case may charge when the case is in the open position. In various embodiments, an ear-worn device can be configured to execute the debris removal protocol when the ear-worn device 100 is positioned within the case 1500 and/or when the case 1500 is charging the ear-worn device.

In various embodiments the case main body 1510 may further include a case heat source 1516. The case heat source can be any suitable type of case heat source such as, a resistive heater, or the like. In various embodiments, the case heat source 1516 is configured to direct heat into the acoustic channel 310 of the ear-worn device 100 when the ear-worn device is positioned within the case 1500. In various embodiments, the case heat source 1516 is configured to direct heat into the acoustic channel 310 of the ear-worn device for a predetermined time interval. In some embodiments, the predetermined time interval can be greater than or equal to 10 seconds, 15 seconds, 20 seconds, or 30 seconds. In some embodiments, the predetermined time interval can be less than or equal to 100 seconds, 75 seconds, 50 seconds, or 30 seconds. In some embodiments, the predetermined time interval can fall within a range of 10 seconds to 100 seconds, or 20 seconds to 75 seconds, or 25 seconds to 50 seconds, or can be about 30 seconds.

In some embodiments, heating the acoustic channel 310 of an ear-worn device 100 can cause foreign matter disposed withing the acoustic channel to lose moisture and become less viscous. In some embodiments, the reduced viscosity of the foreign matter can make it easier to remove from the acoustic channel 310 using one or more actuator arrays 312. In various embodiments, the ear-worn device 100 is configured to execute the debris removal protocol after the acoustic channel of the ear-worn device has been heated by the case heat source for the predetermined time interval.

Referring now to FIG. 16, a schematic block diagram of a case is shown with various components of a case is shown in accordance with various embodiments herein. The block diagram of FIG. 16 represents a generic case device for purposes of illustration. It will be appreciated that cases herein can include a greater or lesser number of components than that shown in FIG. 16.

In various embodiments, the case 1500, a case processor 1644, a case sensor package 1646, a case control circuit 1648, and a case non-transitory computer memory 1650, which are each can be connected to circuit board 1616. The case control circuit 1648 can include various components including, but not limited to, a microprocessor, a microcontroller, an FPGA (field-programmable gate array) processing device, an ASIC (application specific integrated circuit), or the like. The case non-transitory computer memory 1650 can include both volatile and non-volatile memory. The case non-transitory computer memory 1650 can include ROM, RAM, flash memory, EEPROM, SSD devices, NAND chips, and the like. The case non-transitory computer memory 1650 can be used to store data from sensors as described herein, store processed data generated using data from sensors as described herein, provide both functions, and also serve additional functions.

The case 1500 further comprises a case battery 1512 electrically connected to power supply circuit 1654, configured to provide power to the various components of the case 1500 such as the case heat source 1516. One or more charging contacts of case charging structure 1506 are connected to the case battery 1512 and are configured to interface with the charging contacts of one or more ear-worn devices 100.

The case 1500 may further include a case wireless communications device 1658 coupled to the coupled to the first circuit board 1616. The case wireless communications device 1658 can be a BLUETOOTH® transceiver, such as a BLE (BLUETOOTH® low energy) transceiver or another transceiver (e.g., an IEEE 802.11 compliant device). In various embodiments the case wireless communications device 1658 is configured to signal to the ear-worn device 100 when the case is charging the ear-worn device and/or when the case is heating the ear-worn device.

### Methods

Many different methods are contemplated herein, including, but not limited to, methods of making, methods of using, and the like. Aspects of system/device operation described elsewhere herein can be performed as operations of one or more methods in accordance with various embodiments herein.

In various embodiments, operations described herein, and method steps can be performed as part of a computer-implemented method executed by one or more processors of one or more computing devices. In various embodiments, operations described herein, and method steps, can be implemented instructions stored on a non-transitory, computer-readable medium that, when executed by one or more processors, causes a system to execute the operations and/or steps.

In an embodiment, a method of moving debris from an ear-worn device ear-worn device is described herein. The ear-worn device can include a housing defining an acoustic outlet, a receiver disposed inside the housing, and an acoustic channel having an acoustic channel wall formed by the housing. In various embodiments, the ear-worn device can accumulate foreign matter during normal use. For instance, while being worn by a user, foreign matter (e.g., skin cells, dust, body oil, food, ear wax, or the like) can enter the ear-worn device via the ear canal opening. The foreign matter can accumulate in the acoustic channel over time causing the performance of the ear-worn device to suffer.

In various embodiments, the method can include the step of placing the ear-worn device in a charging case after a period of normal use. In some embodiments, the ear-worn device will have foreign matter accumulated in the acoustic channel after the period of normal use. In various embodiments the charging case can include at least a case power supply and a case heat source.

In various embodiments, the method can include directing heat into the acoustic channel of the ear-worn device with the case heat source when the ear-worn device is positioned within the charging case. In some embodiments, the case heat source is configured to direct heat into the acoustic channel of the ear-worn device for a predetermined time interval. In some embodiments, directing heat into the acoustic channel of the ear-worn device can cause any foreign matter accumulated in the acoustic channel to dry out and become less viscous.

In various embodiments, the method can include the step of applying a first control voltage to a first actuator array disposed within the acoustic channel. In some embodiments, this step is performed after directing heat into the acoustic channel of the ear-worn device with the case heat source while the ear-worn device is positioned within the charging case. In various embodiments, the first actuator array can include a first plurality of actuators surrounding a first perimeter of the acoustic channel, wherein each of the first plurality of actuators moves in response to the application of the first control voltage.

In various embodiments, the method can include the step of after applying the first control voltage, applying a second control voltage to a second actuator array disposed within the acoustic channel. In various embodiments, the second actuator array can include a second plurality of actuators surrounding a second perimeter of the acoustic channel, wherein each of the second plurality of actuators moves in response to the application of the second control voltage. In some embodiments, the ear-worn device can include three or more actuator arrays. The activation of each array occurs slightly later than the activation of the previous neighboring array, so that the array closest to the channel opening moves last. Then the cycle repeats.

In various embodiments, the movement of the of the actuators causes foreign matter to be repelled from the acoustic channel out through ear canal opening of the ear-worn device. In various embodiments, the method can include the step of, after repelling the foreign matter from the acoustic channel, removing the ear-worn device from the case and resuming normal use.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An ear-worn device comprising:
a housing defining an acoustic outlet;
a receiver disposed within the housing;
an acoustic channel having an acoustic channel wall formed by the housing, wherein the acoustic is channel defined between the receiver and the acoustic outlet;
a first actuator disposed within the acoustic channel and extending from the acoustic channel wall toward a center of the acoustic channel, the first actuator comprising a piezoelectric layer;
a power source electrically connected to the first actuator; and
an actuator control device configured to apply a control voltage from the power source to the actuator;
wherein the first actuator moves in response to the application of the control voltage.

2. The ear-worn device of claim 1, wherein the first actuator is configured to remove debris from the acoustic channel.

3. The ear-worn device of claim 1, wherein the first actuator is a part of a first actuator array disposed within the acoustic channel, the first actuator array further comprising a second actuator disposed within the acoustic channel and extending from the acoustic channel wall toward the center of the acoustic channel, the second actuator comprising a piezoelectric layer;
wherein the power source is electrically connected to the first actuator array; and
wherein the actuator control device is configured to apply a control voltage from the power source to the first actuator array; and
wherein each of the first plurality of actuators moves in response to the application of the control voltage.

4. The ear-worn device of claim 3, wherein the first actuator array comprises at least ten actuators.

5. The ear-worn device of claim 4, further comprising a second actuator array disposed between the first actuator array and the acoustic outlet, the second actuator array comprising a second plurality of actuators surrounding a second perimeter of the acoustic channel wall, wherein each of the second plurality of actuators extends from the acoustic channel wall toward the center of the acoustic channel.

6. The ear-worn device of claim 5, wherein the actuator control device is configured to apply the control voltage from the power source to the second actuator array after applying the control voltage from the power source to the first actuator array.

7. The ear-worn device of claim 6, wherein the actuator control device is configured to apply the control voltage from the power source to the second actuator array between about 100 milliseconds and one second after applying the control voltage from the power source to the first actuator array.

8. The ear-worn device of claim 5, wherein each of the second plurality of actuators have an angular offset with respect to each of the first actuator and the second actuator.

9. The ear-worn device of claim 5, further comprising a third actuator array disposed between the second actuator array and the acoustic outlet, the second actuator array comprising a third plurality of actuators surrounding a third perimeter of the acoustic channel wall, wherein each of the third plurality of actuators extends from the acoustic channel wall toward the center of the acoustic channel.

10. The ear-worn device of claim 1, wherein the first actuator comprises a passive layer and wherein the piezoelectric layer extends less than 30% of a length of the passive layer.

11. The ear-worn device of claim 1, wherein the first actuator has a length of between about 100 and 500 microns.

12. The ear-worn device of claim 3, further comprising a substrate, wherein the first actuator array extends from the substrate.

13. The ear-worn device of claim 12, wherein the substrate comprises a flexible printed circuit board.

14. The ear-worn device of claim 12, wherein the substrate is disposed inside of the acoustic channel and forms a closed perimeter within the acoustic channel, wherein a first side of the substrate is attached to the acoustic channel wall and each of the first plurality of actuators extends from a second side of the substrate.

15. The ear-worn device of claim 14, wherein the second side of the substrate forms a substantially cylindrical cross section within the acoustic channel.

16. The ear-worn device of claim 12, wherein the substrate forms an insert intercepting a portion of the acoustic channel wall, wherein each of the first plurality of actuators extends from a second side of the substrate.

17. The ear-worn device of claim 16, wherein the second side of the substrate forms a substantially square cross section.

18. An ear-worn device system comprising:
an ear-worn device comprising:
a device rechargeable battery;
a housing defining an acoustic outlet;
a receiver disposed within the housing;
an acoustic channel having an acoustic channel wall formed by the housing, wherein the acoustic is channel defined between the receiver and the acoustic outlet;
a first actuator array disposed within the acoustic channel, the first actuator array comprising a first plurality of actuators surrounding a first perimeter of the acoustic channel wall;
a power source electrically connected to the first actuator array; and
an actuator control device configured to apply a control voltage from the power source to the first actuator array;
wherein each of the first plurality of actuators extends from the acoustic channel wall toward a center of the acoustic channel,
wherein the actuator control device applies the control voltage from the power source to the first actuator array and wherein the first actuator moves in response to the application of the control voltage.

19. The ear-worn device system of claim 18, further comprising a case configured to charge the device rechargeable battery of the first ear-worn device, the case comprising:
a case charging structure for charging the device rechargeable battery of the ear-worn device;
a case rechargeable battery;
a case processor; and
a case non-transitory computer memory;
wherein the actuator control device applies the control voltage from the power source to the first actuator array after the ear-worn device has been positioned in the case.

20. A method of moving debris from an ear-worn device ear-worn device, the ear-worn device comprising a housing defining an acoustic outlet, a receiver disposed inside the housing, and an acoustic channel having an acoustic channel wall formed by the housing, wherein the acoustic is channel defined between the receiver and the acoustic outlet; the method comprising:
applying a first control voltage to a first actuator array disposed within the acoustic channel, the first actuator array comprising a first plurality of actuators surrounding a first perimeter of the acoustic channel; wherein each of the first plurality of actuators moves in response to the application of the first control voltage;
after applying the first control voltage, applying a second control voltage to a second actuator array disposed within the acoustic channel, the second actuator array comprising a second plurality of actuators surrounding a second perimeter of the acoustic channel;
wherein each of the second plurality of actuators moves in response to the application of the second control voltage.
